(19) United States
(12) Patent Application Publication
(10) Pub. No.: US 2017/0331807 A1
(43) Pub. Date: Nov. 16, 2017

(54) HANDS-FREE USER AUTHENTICATION

(71) Applicant: SoundHound, Inc., Santa Clara, CA (US)

(72) Inventors: Bernard MONT-REYNAUD, Sunnyvale, CA (US); Keyvan MOHAJER, Los Gatos, CA (US); Jonah Probell, Alviso, CA (US)

(73) Assignee: SoundHound, Inc., Santa Clara, CA (US)

(21) Appl. No.: 15/225,837

(22) Filed: Aug. 2, 2016

Related U.S. Application Data
(60) Provisional application No. 62/336,476, filed on May 13, 2016.

(51) Int. Cl. H04L 29/06; G10L 15/30; G10L 25/51

(52) U.S. Cl. CPC H04L 63/08; H04L 63/10; G10L 15/30; G10L 25/51

(57) ABSTRACT

A foreign device (FD) authenticates a user by communicating with a personal device (PD) using an audible signal. A system detects audible signals within time windows, and the signals can include codes. Either of the FD and PD can emit an audible signal for reception by the other device. A system uses geolocation, and comparison of audio segments simultaneously captured by each device to determine proximity between the devices. Users can speak audible messages, such as a codes read from PD. Codes can be words or numbers. Either device can enable speech recognition for detecting codes. The FD can also capture a unique user ID. The system can use the unique user ID to lookup a PD's ID.

### CROSS REFERENCE TO RELATED APPLICATION

This application claims priority under 35 USC 119 from U.S. Provisional Application Ser. No. 62/336,476 filed on 13 May 2016, titled HANDS-FREE USER AUTHENTICATION by Bernard MONT-REYNAUD, the entire disclosure of which is incorporated herein by reference.

### FIELD OF THE INVENTION

The invention is in the field of user authentication for human-machine interfaces to electronic devices.

### BACKGROUND

The number of electronic devices in people's lives has been increasing. This includes devices in homes, workplaces, and places for transportation and shopping. Consider music players, virtual assistant, automobile consoles, kiosks, and ATMs. Not only has the number of devices increased, but also the number of different device types and the ways devices are used. Many devices are Internet-connected, and many interact with users based on their profiles. Some user profiles include private information, and some identify the services to which the user has subscribed, together with credentials to access the services. Access to such information requires identifying and authenticating users. However, it is inconvenient for users to type a username and password frequently, as well as having to remember numerous usernames and passwords. This is even less convenient on small devices without keyboards; and it is quite annoying on devices that use a controller with only a few buttons, making it impractical to use typed password authentication.

Devices with voice interfaces could make authentication more convenient by offering users an ability to use a username and static passphrase. However, that is impractical because it is easy for other people to hear the passphrase. This makes such approaches not secure. What is needed is a system and method for a better user interface for devices to identify and authenticate users in a secure way.

### SUMMARY OF THE INVENTION

The invention is directed to a system and method for better interfaces for devices to identify and authenticate users in a secure way. The invention is useful in allowing “foreign” devices to identify and authenticate users and restrict their access to selected functionality. As such the invention provides significant improvements in the control of user access.

A “trust chain” is two or more devices, together with secure connections between them, which are trusted for the purpose of interactions—notably, for the authentication of users or devices with respect to specific applications.

In accordance with various aspects of the invention, various embodiments use audible signals. Some embodiments of the invention use speech, such as a user saying a code aloud. In some embodiments, a user speaks a passphrase. Some embodiments use other kinds of audible signals. Various embodiments rely on an initial trust chain, including a device where the user has been previously authenticated, called the “personal device” for that reason. Typically, people carry their personal devices (such as a smartphone) on their body, or have them nearby (such as a tablet or portable computer). The invention relies on the proximity of the authenticated personal device to the user. In various embodiments, the personal device is coupled with one or more servers of a cloud service provider. Various embodiments expand the trust chain to include the foreign device, for particular applications. In accordance with some aspects and some embodiments, the previously authenticated personal device is portable, and routinely carried by the user. In accordance with some aspects, some embodiments authenticate by emitting a signal from the foreign device and some embodiments authenticate by emitting a signal from the personal device.

An audio symbol is a short segment of audible energy of a constant spectrum. In accordance with some aspects and some embodiments, the signal is a single audio symbol, sent within a specific window of time. For example, some embodiments use a sequence of audio symbols, such as three 50 ms audio symbols with the first two separated by 100 ms, and the third following 50 ms later. Audio symbol duration and spacing are, effectively, an audible bar code. The scope of the invention is not limited by the duration of each audio symbol or the separation time between audio symbols. According to some embodiments, the pattern of audio symbols is unique to a user. According to some embodiments, the pattern is unique to a device. According to some embodiments, the pattern is unique to a specific set of authenticated content, such as a specific genre of music or a specific financial account. According to some embodiments, the pattern is obtained from a server which generates new authentication codes whenever needed.

In some embodiments, an audio signal encodes a code. Some embodiments use geolocation information as part of their authentication process. Some embodiments compare audio segments captured from each of the personal device and the foreign device to confirm that they are in the same location (“co-located”). Some embodiments compare an audio segment captured from a personal device to an audio signal emitted by a foreign device to confirm that the devices are co-located. Some embodiments compare the audio based on audio fingerprints, such as, e.g., those that SoundHound, Inc. uses for music recognition. Some such embodiments store and transmit some audio segments and some audio signals as audio fingerprints.

An audio word is a short sequence of audio symbols, generally of varying spectra, that is useful for encoding a data sequence. In some embodiments, a foreign device outputs an audio word and a personal device attempts to detect the audio word in a captured input audio segment. In some embodiments, a personal device outputs an audio word and a foreign device attempts to detect the audio word in a captured input audio segment. In some embodiments, an audio word is a single audio symbol.

In some such embodiments, an audio word encodes information. In some embodiments, an audio word encodes information using Dual-Tone Multi-Frequency (DTMF) codes. In some such embodiments, the nominal DTMF code frequencies are shifted (generally lowered) to a range that best penetrates materials, while staying within a range at which an audio sensor has good sensitivity (above 200 Hz for many microphones). Many materials act as low-pass filters, and acoustic energy begins to fall off significantly above a certain frequency, such as 2500 Hz or a lower frequency.

Some embodiments of the invention rely on direct digital communication between the personal device and the foreign device. Some embodiments rely on digital communication with a server of a cloud service provider. In various embodiments, the server performs one or more of: an authentication function; a speech recognition function; a code generation function; a time synchronization function; an audio matching function; and a content distribution function.

In some embodiments, a personal device generates a text-based code. In some embodiments, a server generates a text-based code. In some embodiments, the code is numerical. Some embodiments encode a textual or numerical code into an audio signal. Some embodiments extract a textual or numerical code from a stream of audio samples. In some embodiments, the audio encoding uses speech, and the code extraction uses a speech recognition function. In some embodiments, the audio encodings use DTMF, and the code extraction uses corresponding DTMF recognizers.

Some embodiments require a user ID, called UID for short, which must be unique within the scope of the application or relevant environment. In accordance with some aspects of the invention, a user speaks a UID. In some embodiments, the personal device emits a UID. In some embodiments, the UID is a name. In some embodiments, the UID is an email address. In some embodiments, a server uses the UID to retrieve a unique ID of a personal device.

In some embodiments, a cloud service provider server controls access to content such as purchased music, subscriptions, or financial data. Some embodiments revoke access after a certain timeout period, and require re-authentication for continued access. In some embodiments, the system re-authenticates automatically, and revokes access if the re-authentication attempt fails. In some embodiments, a user can explicitly revoke authentication.

The various aspects of the invention, as set forth in the various embodiments, show examples of significant improvements in the field of authentication. The combinations of features outlined represent novel improvements to traditional methods of authentication. For example, the systems and methods disclosed, in accordance with some aspects and embodiments, use the ability to analyze a captured audio segment and compare it to a known audio segment or an expected audio segment or to a second captured audio segment in order to determine similarities and differences between the audio segments, and the ability to exchange sounds between two devices using audio as well as a data channel. The combinations of features captured in the various embodiments introduce novel concepts, which collectively represent significant improvements in the field of authentication.

### BRIEF DESCRIPTION OF THE DRAWINGS

The foregoing summary as well as the following detailed description is better understood when read in conjunction with the appended drawings. For the purpose of illustrating the invention, there is shown in the drawings exemplary embodiments in accordance with various aspects of the invention. However, the invention is not limited to the specific embodiments and methods disclosed. In the drawings:

FIG. 1 illustrates a block diagram of a wireless communication device according to an embodiment of the invention.

FIG. 2 illustrates a user reading a code from a personal device and speaking the code to a foreign device according to an embodiment of the invention.

FIG. 3 illustrates an event sequence of a user requesting a code from a server through a personal device according to an embodiment of the invention.

FIG. 4 illustrates an event sequence of a user requesting a code from a server through a foreign device according to an embodiment of the invention.

FIG. 5 illustrates a state diagram of a foreign device according to an embodiment of the invention.

FIG. 6 illustrates a personal device signaling a foreign device according to an embodiment of the invention.

FIG. 7 illustrates an event sequence of a personal device signaling a foreign device according to an embodiment of the invention.

FIG. 8 illustrates a state diagram of a personal device according to an embodiment of the invention.

FIG. 9 illustrates a foreign device and personal device both capturing ambient sound according to an embodiment of the invention.

FIG. 10 illustrates a foreign device communicating with a personal device through a wireless network according to an embodiment of the invention.

FIG. 11 illustrates a personal device performing geolocation using radio beacons according to an embodiment of the invention.

### DETAILED DESCRIPTION

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates, which may need to be independently confirmed.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Accordingly, elements or features of the invention described herein as coupled have an effectual relationship realizable by a direct connection or indirectly with one or more other intervening elements.

Any methods and materials similar or equivalent to those described herein can also be used in the practice of the invention. Representative illustrative methods and materials are also described, but are not intended to limit the scope of the invention, which is defined by the claims that follow.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. It is noted that, as used herein, the singular forms “a,” “an” and “the” include plural referents unless the context clearly dictates otherwise. Reference throughout this specification to “one aspect,” “another aspect,” “one embodiment,” “an embodiment,” “certain embodiment,” or similar language means that a particular aspect, feature, structure, or characteristic described in connection with the embodiment is included in at least one embodiment of the invention. Thus, appearances of the phrases “in one embodiment,” “in at least one embodiment,” “in an embodiment,” “in certain embodiments,” and similar language throughout this specification may, but do not necessarily, all refer to the same embodiment or similar embodiments.

Most users these days carry with themselves devices, such as mobile phones, which are portable and authenticated, with microphones and speakers. For example, mobile phones are tied to a user account through an international mobile station equipment identity (IMEI) code. Somebody sending a phone call or text message to a phone number can trust that the international phone system will route the call or message to that phone number's phone and none other.

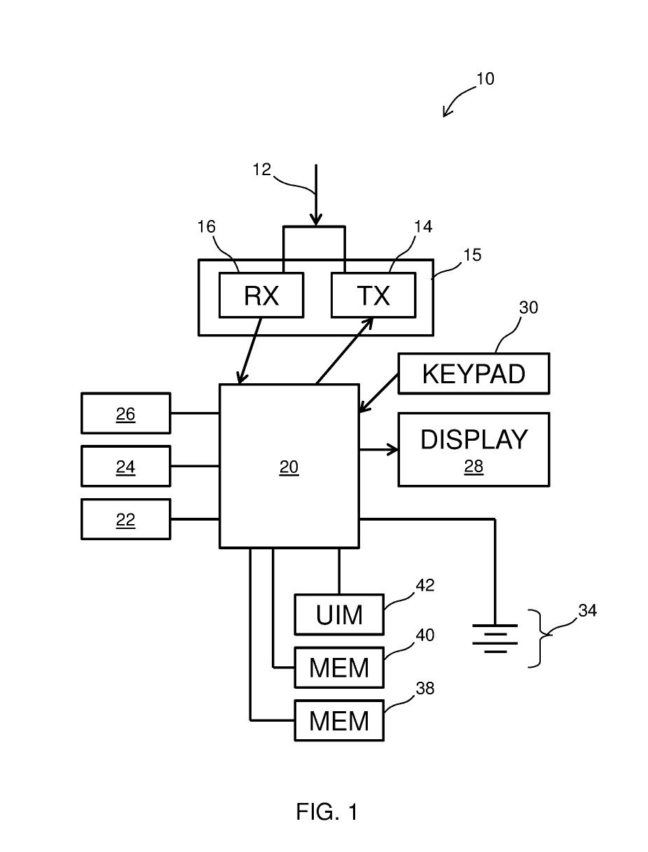

Referring to FIG. 1, based on the various aspects and embodiments of the invention, illustrates a block diagram of a wireless device 10, such as a mobile telephone or a mobile terminal. It should be understood, however, that the wireless device 10, as illustrated and hereinafter described, is merely illustrative of one type of wireless device and/or mobile device that would benefit from embodiments of the invention and, therefore, should not be taken to limit the scope of embodiments of the invention. While several aspects and embodiments of the wireless and mobile device are illustrated and will be hereinafter described for purposes of example, automobiles, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ aspects and embodiments of the invention.

In addition, while wireless device 10 uses several embodiments of the method of the invention, the method may be employed by other than a wireless device or a mobile terminal. Moreover, the system and method of embodiments of the invention will be primarily described in conjunction with mobile communications applications. It should be understood, however, that the invention could be utilized in conjunction with a variety of other applications, both in the mobile communications industries and outside of the mobile communications industries.

The wireless device 10 includes an antenna 12 (or multiple antennae) in operable connection or communication with a transmitter 14 and a receiver 16 in accordance with one aspect of the invention. In accordance with other aspects of the present invention, the transmitter 14 and the receiver 16 may be part of a transceiver 15. The wireless device 10 may further include an apparatus, such as a controller 20 or other processing element, which provides signals to and receives audio segments from the transmitter 14 and receiver 16, respectively. The signals include signaling information in accordance with the air interface standard of the applicable cellular system, and also user speech, received data and/or user generated data. In this regard, the wireless device 10 is capable of operating with one or more air interface standards, communication protocols, modulation types, and access types.

By way of illustration, the wireless device 10 is capable of operating in accordance with any of a number of first, second, third and/or fourth-generation communication protocols or the like. For example, the wireless device 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the wireless device 10 may be capable of operating in accordance with non-cellular communication mechanisms. For example, the wireless device 10 may be capable of communication in a wireless local area network (WLAN) or other communication networks. The wireless device 10 can also have multiple networking capabilities including nomadic wired tethering, local-area-network transceivers (e.g. IEEE802 Wi-Fi), wide-area-network transceivers (IEEE 802.16 WiMAN/WiMAX, cellular data transceivers, (e.g. LTE) and short-range, data-only wireless protocols such as Ultra-wide-band (UWB), Bluetooth, RFID, Near-field-communications (NFC), etc.

It is understood that the apparatus, such as the controller 20, may include circuitry desirable for implementing audio and logic functions of the wireless device 10. For example, the controller 20 may comprise a digital signal processor device, a microprocessor device, and various analog to digital converters, digital to analog converters, and other support circuits. Control and signal processing functions of the wireless device 10 are allocated between these devices according to their respective capabilities. The controller 20 may also include the functionality to encode and interleave message and data prior to modulation and transmission. The controller 20 can additionally include an internal voice coder, and may include an internal data modem. Further, the controller 20 may include functionality to operate one or more software programs, which may be stored in memory, such as speech recognition programs. For example, the controller 20 may be capable of operating a connectivity program, such as a conventional Web browser. The connectivity program may then allow the wireless device 10 to transmit and receive Web content, such as location-based content and/or other web page content, according to a Wireless Application Protocol (WAP), Hypertext Transfer Protocol (HTTP) and/or the like, for example.

The wireless device 10 may also comprise a user interface including an output device such as a conventional earphone or speaker 24, a ringer 22, a microphone 26, a display 28, and at least one user input interface, all of which are coupled to the controller 20. The user input interface, which allows the wireless device 10 to receive data, may include any of a number of devices allowing the wireless device 10 to receive data, such as a keypad 30, a touch display (not shown) or another input device. In embodiments including the keypad 30, the keypad 30 may include the conventional numeric (0-9) and related keys (#, *), and other hard and soft keys used for operating the wireless device 10. Alternatively, the keypad 30 may include a conventional QWERTY keypad arrangement. The keypad 30 may also include various soft keys with associated functions. In addition, or alternatively, the wireless device 10 may include an interface device such as a joystick or another user input interface. The wireless device 10 further includes a battery 34, such as a vibrating battery pack, for powering various circuits that are required to operate the wireless device 10, as well as optionally providing mechanical vibration as a detectable output. Alternatively, or in addition, wireless device 10 may include an energy harvester.

The wireless device 10 may further include a user identity module (UIM) 42. The UIM 42 may be a memory device having a processor built in. The UIM 42 may include, for example, a subscriber identity module (SIM), a universal integrated circuit card (UICC), a universal subscriber identity module (USIM), a removable user identity module (R-UIM), etc. The UIM 42 typically stores information elements related to a mobile subscriber. In addition to the UIM 42, the wireless device 10 may be equipped with memory. For example, the wireless device 10 may include volatile memory 40, such as volatile Random Access Memory (RAM) including a cache area for the temporary storage of data, including captured input audio segments. The wireless device 10 may also include other non-volatile memory 38, which can be embedded and/or may be removable. The non-volatile memory 38 can additionally or alternatively comprise an electrically erasable programmable read only memory (EEPROM), flash memory or the like, such as that available from the SanDisk Corporation of Milpitas, Calif., or Micron Consumer Products Group Inc. of Milpitas, Calif. The memories can store any of a number of pieces of information, and data, used by the wireless device 10 to implement the functions of the wireless device 10. For example, the memories can include an identifier, such as an international mobile equipment identification (IMEI) code, capable of uniquely identifying the wireless device 10. Furthermore, the memories may store instructions for determining cell id information. Specifically, the memories may store an application program for execution by the controller 20, which determines an identity of the current cell, i.e., cell id identity or cell id information, with which the wireless device 10 is in communication.

Although not every element of every possible mobile network is shown and described herein, it should be appreciated that the wireless device 10 may be coupled to one or more of any of a number of different networks through a base station (not shown). In this regard, the network(s) may be capable of supporting communication in accordance with any one or more of a number of first-generation (1G), second-generation (2G), 2.5G, third-generation (3G), 3.9G, fourth-generation (4G), fifth-generation (5G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the invention, as should dual or higher mode mobile stations (e.g., digital/analog or TDMA/CDMA/analog phones).

The wireless device 10 can further be coupled to one or more wireless access points (APs) (not shown). The APs may comprise access points configured to communicate with the wireless device 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs may be coupled to the Internet (not shown). The APs can be directly coupled to the Internet. In accordance with other aspects of the invention, the APs are indirectly coupled to the Internet. Furthermore, in one embodiment, the BS may be considered as another AP.

As will be appreciated, by directly or indirectly connecting the wireless devices 10 to the Internet, the wireless device 10 can communicate with other devices, a computing system, etc., to thereby carry out various functions of the wireless device 10, such as to transmit data, content or the like to, and/or receive content, data or the like from other devices. As used herein, the terms “data,” “content,” “information” and similar terms may be used interchangeably to refer to data capable of being transmitted, received and/or stored in accordance with the various aspects and embodiments of the invention. Thus, use of any such terms should not be taken to limit the spirit and scope of embodiments of the invention.

Although not shown, the wireless device 10 may communicate in accordance with, for example, RF, BT, IrDA or any of a number of different wireline or wireless communication techniques, including LAN, WLAN, WiMAX, UWB techniques and/or the like. One or more of the computing systems that are in communication with the wireless device 10 can additionally, or alternatively, include a removable memory capable of storing content, which can thereafter be transferred to the wireless device 10. Further, the wireless device 10 can be coupled to one or more electronic devices, such as displays, printers, digital projectors and/or other multimedia capturing, producing and/or storing devices (e.g., other terminals). Furthermore, it should be understood that embodiments of the invention may be resident on a communication device such as the wireless device 10, or may be resident on a network device or other devices accessible to the wireless device 10.

In accordance with the various aspects of the invention, the wireless device 10 includes on board location systems. While the on-board location systems (e.g. Global-Navigation-Satellite-System Receivers (GNSS)) may be used to develop a location estimate for the wireless device 10, the location of a wireless device 10 may be determined from the interaction (i.e. radio messaging) between the wires device 10 and the network (e.g. cellular system, WiMAN, WiMAX, WiFi, Bluetooth, NFC).

Various companies, such as banks and Google, rely on this to authenticate users when they connect to companies' sites through an unrecognized computer. When a user tries to connect through an unrecognized computer, the company sends a text message or makes a phone call to the user's mobile phone with a code. If it is truly the user at the unrecognized computer, then the user types in the code. That way the company knows that it is truly that user using the unrecognized computer. That is a two-factor authentication. The first factor is that the user authenticates by typing a username and password. The second factor is that the user also types in a code. In such systems, the code expires within a certain time period. That way, somebody who steals the username and password still cannot access the user profile known by the company.

It is also true that when a user logs into an app or the operating system of a phone, companies trust that when they send a message to the app on that user's phone, only that user's phone will get the message. In this way, any company that offers apps for mobile phones or similar personal portable devices can consider the device trusted.

Audible authentication has certain advantages over electronic methods. Audible methods are slower, making repeated guessing impractically slow for gaining unauthorized access. Furthermore, since bystanders can hear such an attack, they would become suspicious. Furthermore, audible authentication is less susceptible to jamming than RF communication since people would notice the audible signal.

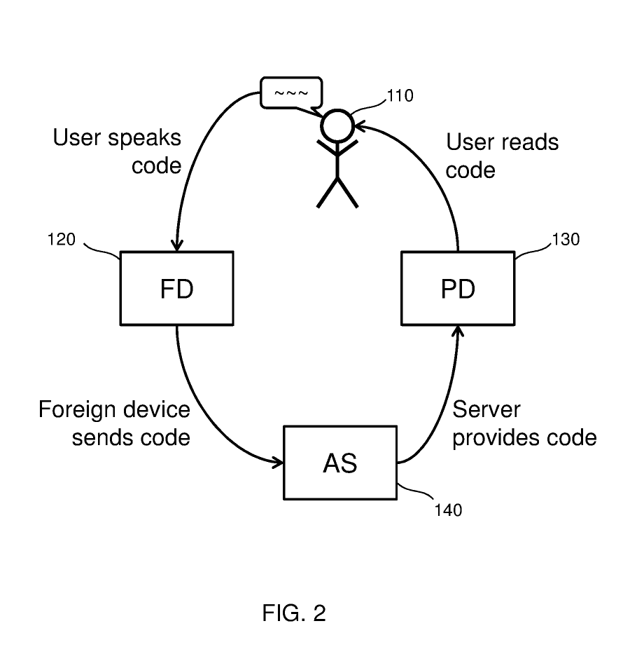

FIG. 2 shows an embodiment of the invention in which a user 110 speaks a code for authentication with a foreign device (FD) 120. User 110 reads the code from a personal device (PD) 130, which receives the code, provided by an authentication server (AS) 140 over a trusted connection. FD 120 captures the spoken code from user 110 and sends the captured code to the AS 140. The AS 140 compares the code received from FD with the code sent to PD, and upon a match, completes the authentication and informs FD (not shown) of the completion.

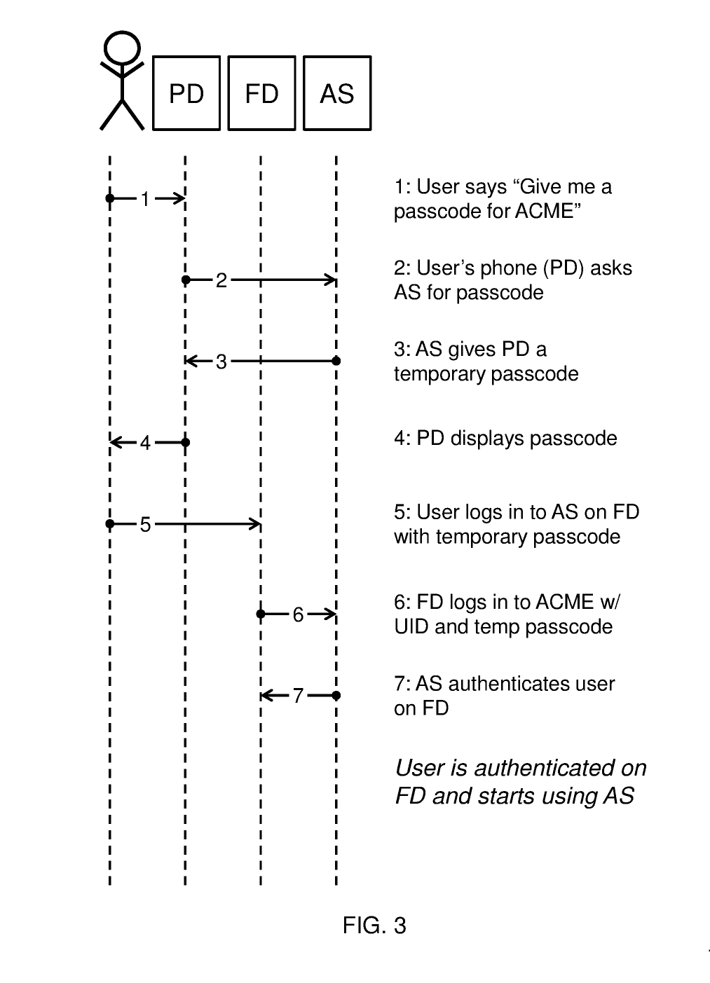

Referring to FIG. 3, in some embodiments, the user requests the code by invoking a mobile phone app, tapping a button, and the phone app retrieving a code from the server. FIG. 3 shows a scenario of a more hands-free experience. In step 1, a user speaks to a personal device (PD), requesting a temporary passcode for a specific application or service available on foreign device FD. In step 2, the PD sends a passcode request to the AS over a trusted connection. The AS generates and stores a temporary passcode. In step 3, the AS sends the temporary passcode to the PD over a trusted connection. In step 4, the PD displays the temporary passcode as text. In step 5, the user requests access to FD, then reads the passcode aloud. In step 6, the FD sends the passcode to the AS. The AS receives the passcode and compares it to the stored passcode. In step 7, if the codes match, the server responds to the FD indicating a successful authentication. In some embodiments, the server proceeds to send authorized content to the FD.

In step 7, when the codes do not match, the AS may report a failure to the FD. In accordance with some aspects and some embodiments, if the codes do not match, the server provides no response. In accordance with some aspects and some embodiments, if the codes do not match, the server sends a response that indicates successful (partial) authentication, but takes note of the mismatch and restricts access to certain content.

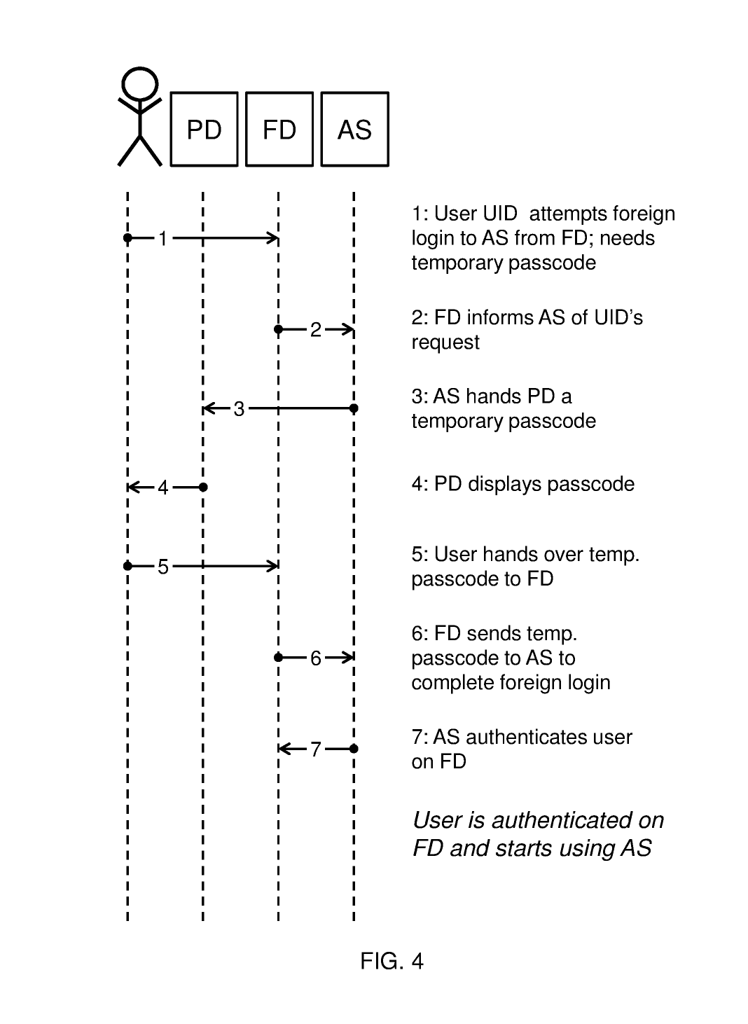

FIG. 4 shows an embodiment similar to that of FIG. 3. However, in step 1 the user speaks to the FD to request a passcode. In step 2, the FD sends the passcode request to the AS. It is not essential that the connection between FD and AS be trusted. An inappropriate request will cause the PD to alert the user, even if the user is not in close proximity to the FD.

According to some embodiments, to prevent a malicious FD user from causing excessive annoying messages to the user's PD, the AS limits the number of code requests allowed within a certain time window, such as three within any ten-minute period. To prevent a malicious FD user from sending excessive requests to the AS, some systems require the FD to limit the number of requests that it sends within a certain time window.

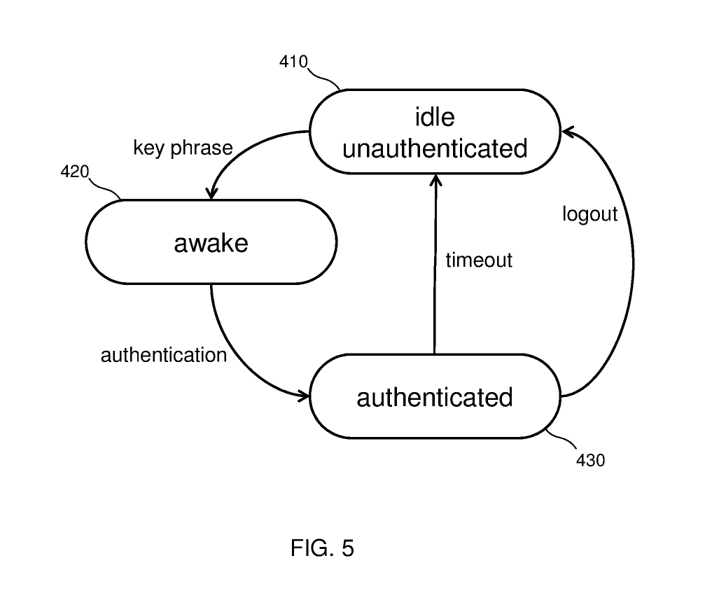

Referring to FIG. 5, it is important that a system revoke authentication, appropriately, to prevent unauthorized access after the user stops using the FD. FIG. 5 shows a FD state diagram. The FD begins in an idle, unauthenticated state 410. The FD listens for a key phrase, also called wake-up phrase, that puts the FD in an awake state 420. While the FD remains in the awake state 420, it receives any detectable code, and makes one or more authentication requests to the AS. When the AS responds with a successful authentication message, the FD proceeds to an authenticated state 430. It remains in authenticated state 430 until a timeout occurs, or a user issues a logout command, by tapping, typing, or saying “Disconnect” is some form.

The timeout period varies from one embodiment to another according to the aspects of the invention. An automatic teller machine (ATM) embodiment may time out after 20 seconds of inactivity. A music player may time out after 3 hours without user activity. Some embodiments allow persistent authentication, and never timeout. Some embodiments allow the user to specify a duration or a specific time for authentication to remain active. Some such embodiments use a natural language query to specify a timeout duration or expiration time.

In some embodiments, the PD does speech recognition. In some embodiments, the FD does speech recognition. In some embodiments, the FD or the PD sends audio segments to the AS or another server, which does speech recognition. All such cases provide for a hands free experience. Speech recognition extracts textual information from the received audio segments. Various kinds of server-based and embedded speech recognition application software are appropriate.

Speech recognition is often difficult for usernames or email addresses, which tend to consist of proper nouns or idiosyncratic sequences of symbols that have low frequency in word statistics dictionaries. Spelling things out a symbol at a time can be slow. The need for a unique UID goes counter to the need for simple speech recognition. For ease of remembering and speech recognition, some embodiments allow the user to choose a spoken user ID or passphrase. According to some embodiments, the system uses number sequences instead of unique names to identify users. A phone number is one such number sequence, one that most users remember easily.

Transferring a code between a personal device and a foreign device is a challenge in some environments. A user-spoken code allows bystanders to eavesdrop and gain unauthorized access. This can be very costly in case of a financial transaction. Furthermore, a legitimate (paying) user of a service can share a spoken code by voice, telephone, or text with a non-paying user, resulting in a loss of a customer acquisition opportunity for the service provider or content vendor.

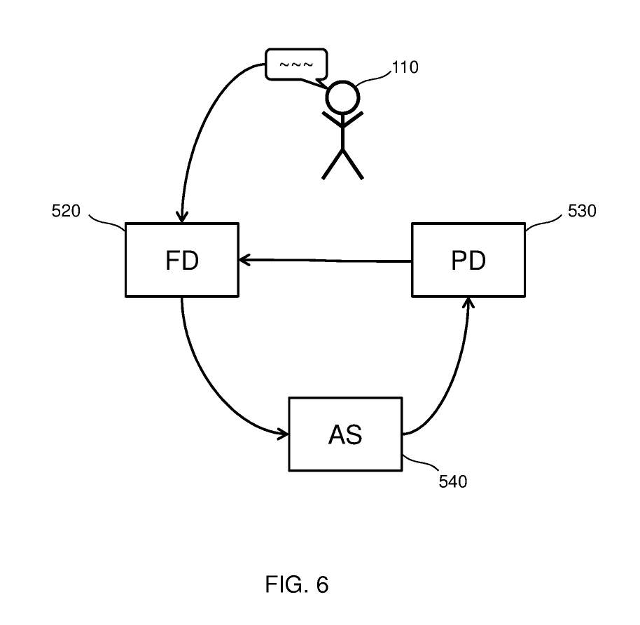

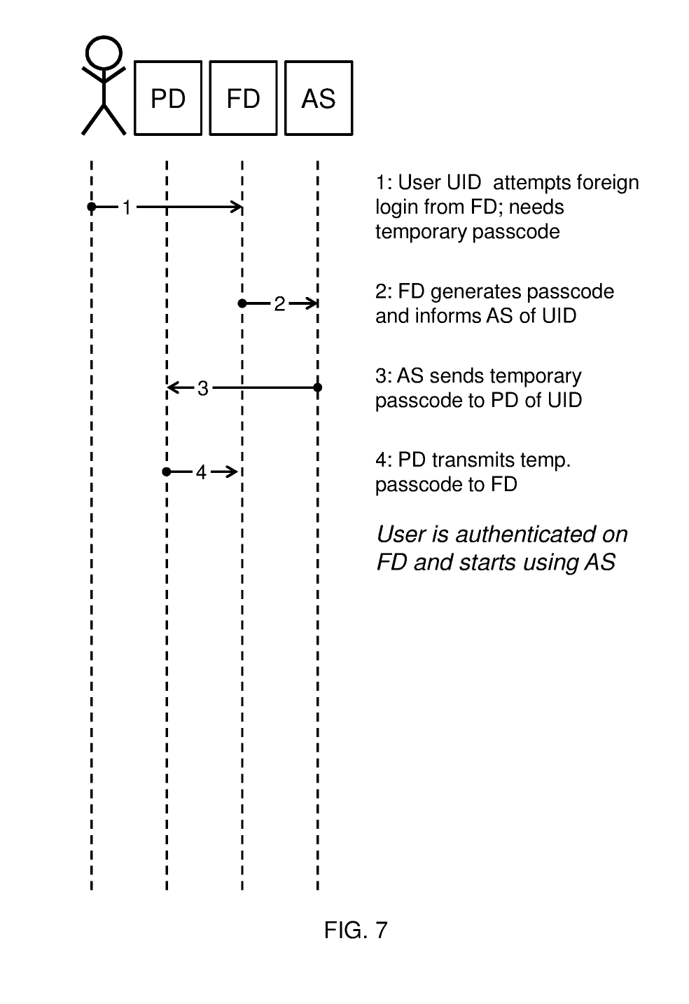

FIG. 6 and FIG. 7 show an embodiment of the invention. In step 1, user 110 speaks a UID to a FD 520, such as by saying, “I'm Rumpelstiltskin@Acme.com”. In step 2, the FD 520 generates a pseudorandom authentication code and sends the UID and authentication code to an AS 540. In step 3, the AS 540 sends the code to a PD 530, which the AS 540 knows to be associated with the UID. The AS 540 uses a trusted connection. In step 4, the PD 530 receives the code and emits it, audibly, to the FD 520. The FD 520 receives the code and can confirm or deny authentication.

In some embodiments, the FD 520 simply listens for a sharp audible impulse within a period slightly greater than the maximum tolerable network lag. The PD 530 simply generates such an impulse when it receives a message from the AS 540. Only if the PD 530 is in close proximity to the FD 520 will it receive the impulse and confirm authentication. This technique has a very low latency, but it requires an appropriate environment, in which the likelihood of an impulse of the recognized type within any given period is sufficiently low.

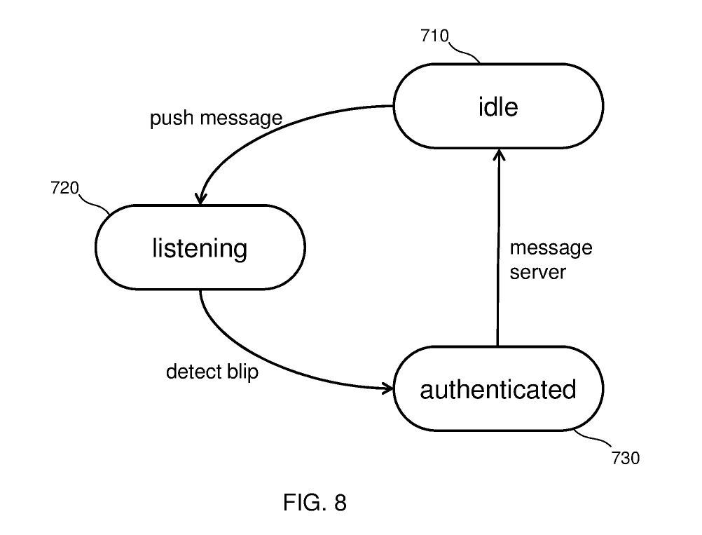

Referring to FIG. 8, it is not necessary for the PD to emit an impulse to be received by the FD if, instead, the FD sends an impulse to be received by the PD. This approach can be superior if the FD has a more powerful speaker than the PD. The emitted audio signal must have enough power for the microphone capturing the audio segment to discern the signal from ambient noise. FIG. 8 shows a state diagram for a PD according to such an embodiment. The PD is initially in an idle state 710. When the PD receives a push message from an AS, it enters a listening state 720 and sends an acknowledgement message to the AS. The AS sends a message to the FD, which then emits an audio word. When the PD recognizes the audio word, it enters authenticated state 730 and immediately sends a message to the AS. The AS then sends an authentication message to the FD.

In some embodiments, the PD decodes the audio word and sends the data sequence to the AS, which performs the authentication. In some embodiments, the PD recognizes that an audio word occurred, and sends the audio word audio to the AS, which in turn decodes the data sequence.

Many users carry a PD in a pocket or a bag. In that case, the audible signal must pass through at least one layer of cloth or other material. If the PD cannot receive an audible signal from the FD, or the other way around, the user can enable authentication by removing the PD from the pocket or bag, but this requires using one's hands. A truly hands-free experience requires the sound to penetrate cloth, leather, plastic, or other materials used to make pockets and bags. Most such materials have the highest coefficient of acoustic energy transmission at low frequencies in the audible range.

The inexpensive, lightweight, miniature MEMS microphones found in many mobile devices, such as mobile phones, have good sensitivity at and above 200 Hz. According to some embodiments, the FD sends a 100 ms audio symbol at 200 Hz. If the PD detects a 200 Hz audio symbol, while in a listening state, then the PD sends a message to the FD, which in turn authenticates the user.

Some embodiments have greater security, by choosing the frequencies used for the audio symbol unpredictably, once for each authentication cycle. A range of frequencies from 200 Hz to 400 Hz is appropriate for some embodiments. In such cases, an initiation message informs both PD and TD of the chosen frequency or frequency sequence.

According to some embodiments, the FD encodes data in an audio word. Many data encoding methods are applicable, such as various forms of frequency-shift keying (FSK), various forms of phase-shift keying (PSK), amplitude-shift keying, and multi-frequency signaling. One well-known method of multi-frequency signaling used in the audible frequency range of acoustic signaling is the dual-tone multi-frequency (DTMF) signaling protocol, which the Bell System developed for Touch-Tone telephone dialing.

The DTMF protocol uses four frequencies, each representing a different horizontal row on a keypad, and four frequencies, each representing a different vertical column on a keypad, the frequencies being in the range from 697 Hz to 1633 Hz, chosen such that they do not share harmonics. DTMF devices operate by transmitting and decoding one horizontal frequency and one vertical frequency simultaneously. The result yields 4×4=16 possible combinations of two simultaneous frequencies; these 16 values can encode 4 bits of information per audio symbol.

Some embodiments of the invention use a signaling protocol equivalent to DTMF, but with all frequencies shifted down by the same factor, so that the new lowest frequency is 200 Hz. Six cycles of a given frequency provides reliable detection. The lowest frequency requires the longest time to detect. A 200 Hz signal has a 5 ms period and is detected reliably in 30 ms, as are the other frequencies. Decoding 4 bits per 30 ms provides is 133 baud (bits per second) signaling rate. This is sufficient to send a full 128-bit RSA key within one second, and a 256-bit RSA key within two seconds. In some embodiments, short keys are sufficient, and correspondingly short transmission times.

In some embodiments, startup of data transmission in an audio word requires a synchronization word. Some embodiments use two sequential ASCII SYN characters (0x1616).

As we have seen, the direction of emitting and receiving audio is immaterial to creating authentication. In accordance with some aspects of the invention, if the FD is line powered or larger than the PD, the FD should do the emitting; otherwise the PD should do the emitting.

Transferring an impulse within a window or an audio word of data allows authentication. However, systems require de-authentication. In some embodiments, the user de-authenticates by speaking a logout command. In some embodiments, when a user requests authentication, she indicates a duration for authentication. In some embodiments, authentication times out. According to some embodiments, an ATM times out after (say) 10 seconds of inactivity, prompts the user to see if she needs more time, and de-authenticates if no answer is received.

In some embodiments, the system re-authenticates automatically from time to time. In order to save power and minimize privacy invasion, a system should perform re-authentication should occur as rarely as possible, and certainly with a longer cycle time than the duration of audio segments needed for re-authentication. Most systems do not require re-authentication more frequently than once per minute. However, systems should re-authentication frequently enough that, after an authorized user leaves, unauthorized users get little enough free valuable content that they will feel frustrated for lack of their own authorization. Most systems should re-authenticate, and restrict access as appropriate, at least once per hour.

According to some embodiments, the FD is a device that plays music provided by a service provider. The system grants a user access by audible authentication through their PD. In some embodiments, continued authentication requires the presence of the user near the FD. Such presence is verified by the PD capturing an audio segment and detecting a message generated by the FD, such as a greeting or menu of voice control options, the approximate timing of which is communicated to the PD to allow a potentially successful comparison to be made.

According to some embodiments for a FD music player, the system automatically re-authenticates from time to time. This occurs by the PD sampling ambient sound, under the control (say) of app software. The music service provider pushes sampling requests to the app, which accesses the PD microphone, samples audio, processes it for network transmission, and sends the processed audio to the service provider. The service provider searches a buffer of source audio for the audio signal to match the captured audio segment. Matching the audio segment in the audio signal source data confirms that the sampled audio contains the music that it is providing to the FD, allowing an appropriate range of time offset for the maximum network latency. If the music is found in the captured audio, the service provider continues providing music to the FD. If the service provider cannot identify the provided music within the audio captured by the PD, the service provider stops sending music to the FD.

In some embodiments the AS forwards captured audio to a music recognition service that identifies a playing song. The AS uses the identity of the presently playing song to authenticate the user at the FD. In some embodiments, the PD captures audio continuously until the music recognition service indicates a successful identification or reports a failure. At that point, the music service informs the AS, which informs the PD to stop capturing audio.

According to some embodiments, the device that performs authentication, such as a FD or server, does so by storing a digital representation of the audio signal in a memory device, such as a RAM, Flash, hard disk drive, or solid-state disk drive. In some embodiments, the digital representation is a set of raw digital audio sample values. In some embodiments, the digital representation is a compressed representation, such as an audio fingerprint of the type used for music recognition libraries such as those of SoundHound and described in US Patent Application Publication No. US 20120029670 A1. In some embodiments, the digital representation is an index value to lookup a digital audio signal in a codebook.

In some embodiments, a semiconductor chip comprising a processor reads samples of the captured audio segment and compares them to samples of the stored audio signal. Authentication succeeds if the stored audio segment matches the stored audio signal within a range of time offset. Various algorithms for audio matching are known and applicable to the present invention; the general idea is to find the maximum cross-correlation of the two signals, or more likely, noise-resistant transforms of the two signals, within the given range of time offset. Algorithms vary notably in the choice of the noise-resistant transform, which might include mapping signals to the frequency power domain and performing compression, as well as noise filtering and distortion compensation. According to various embodiments, software instructions embody and represent the audio signal processing algorithms. The processor carries out the algorithms by executing the software. The processor, upon matching the audio segment within the audio signal, or processing the entire audio segment without matching it in the stored signal, sends an authentication or a de-authentication signal, respectively, to the foreign device. The signal actuates authentication or restriction of access to the desired functionality of the foreign device.

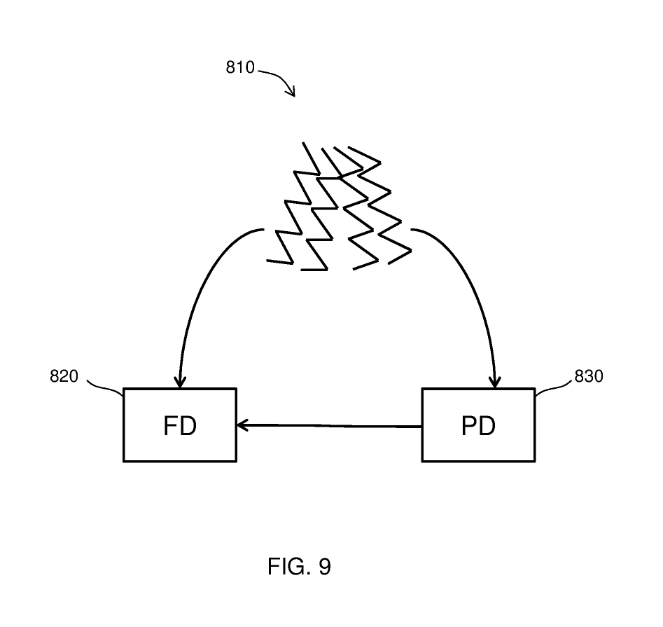

Referring to FIG. 9, in some embodiments, authenticating with an impulse, audio symbol, or audio word would annoy users. That is particularly true for systems that require frequent re-authentication. A passive approach avoids this problem. In a passive approach both devices listen, but do not generate sounds. FIG. 9 shows an embodiment that re-authenticates periodically by sampling ambient sound. A FD 820 captures ambient sound 810 continuously and keeps track of time. Intermittently, a PD 830 captures ambient sound and sends it to the FD 820 along with a time reference. In on embodiment, FD 820 compares the sound captured by the PD 830 to its own captured sound; it uses reference times to predict an approximate alignment hypothesis. Audio matching is performed between the approximately aligned sound segments respectively captured by the PD 830 and the FD 820 at substantially the same time, allowing a small additional time offsets from the predicted alignment to compensate for small transmission and processing delays.

In some embodiments, an AS receives sound samples from both the FD 820 and the PD 830, together with time references, and performs the audio matching comparison in the same way. In some embodiments a device or server performs filtering, transforms, and fingerprinting on the captured audio. Performing accurate comparison of sampled sound requires a sufficiently long audio segment duration. Also, comparisons will not be very useful in the absence of sufficiently audible and distinguishable features. Trying to match fan noise from FD and PD is hopeless, but matching speech, or the clatter of a restaurant, quickly provide information to decide if a match exists. Some embodiments use a sufficiently long duration. Some embodiments capture sound until reaching a certain amount of captured sound energy. In some embodiments, an appropriate information-theoretic measure of feature saliency is extracted and cumulated to determine that a sufficient basis has been formed for a meaningful comparison. In some such embodiments, the feature variability (or transient energy) is a major contribution to the needed measure.

In some embodiments, ambient sound sampling occurs while the personal device is in a locked mode. This is useful when a user wishes to remain authenticated and temporarily leaves a personal device in the vicinity of the foreign device, while preventing others from using the personal device. This is useful, for example, if a party guest who has authenticated her music account steps away to use the washroom.

In some embodiments, a user can reset the authentication period timer by intentionally invoking re-authenticating. In such a scenario, the user accesses the FD or PD, by speaking or tapping on an app, and asks for immediate re-authentication, which has the effect of starting a new cycle.

In some embodiments, the system refrains from revoking access until after a certain number of successive authentication failures. This is also useful, for a party guest who goes to the washroom or leaves the building to smoke a cigarette. Such an embodiment re-authenticates (say) every 3 minutes, and allows (say) three successive authentication failures before revoking access to music. That allows an authorized user to leave the audible range of the music for up at least 9, and up to 12, minutes without the music stopping.

The intermittent re-authentication should occur frequently enough to avoid the consumption of significant content without authorization. However, it should be infrequent enough that it does not consume excessive battery power. While continuous capture is applicable to some embodiments, it consumes too much power for some mobile personal devices. There are also privacy issues surrounding continuous capture, as personal conversations and audible activities may be discernable.

Re-authentication with a mobile phone requires use its microphone. If another app of a phone call takes exclusive control of the microphone data, re-authentication is blocked. Some embodiments do not revoke access if re-authentication is blocked, say, while a phone call is in progress.

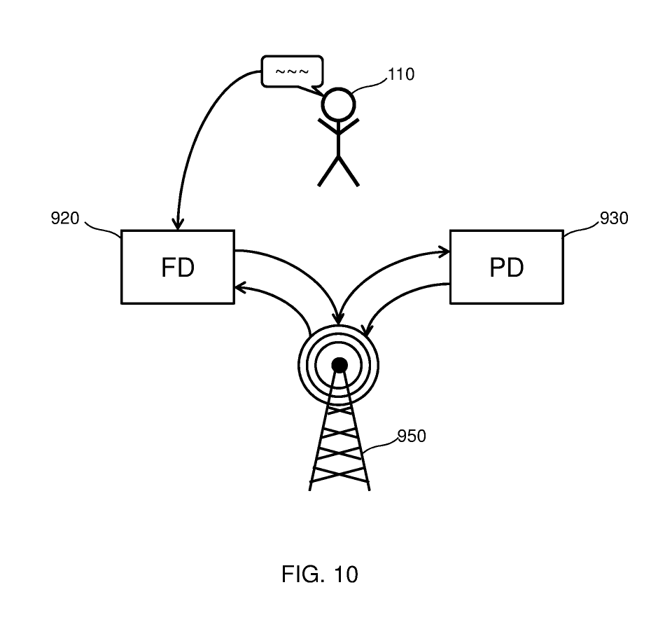

FIG. 10 shows an embodiment of the invention that does not use a server. User 110 speaks to a FD 920. The FD 920 sends a message to a PD 930 through mobile network transceiver tower 950. In accordance to some aspects and some embodiments of the invention, the network is a 5G LTE mobile network. In various embodiments FD 920 and PD 930 interact according to appropriate protocols through WiFi, Bluetooth, Ethernet, USB, or other known methods of wired or wireless data communication between devices that are capable of transferring digital data representing audio.

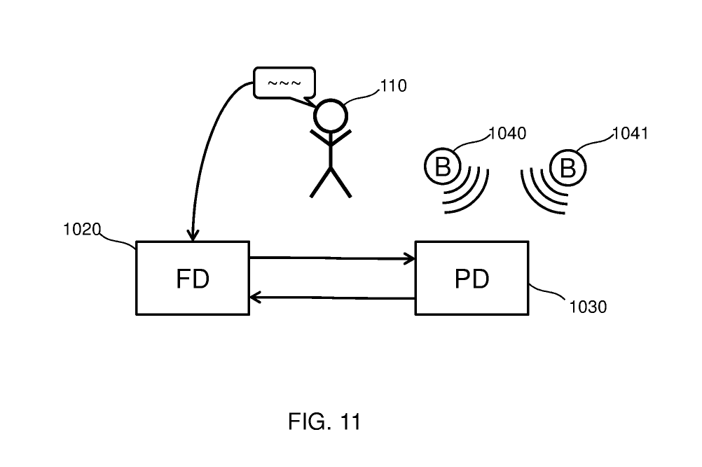

FIG. 11 shows an embodiment of the invention that uses geolocation information. User 110 speaks to a FD 1020, which communicates with a PD 1030. The PD 1030 receives location information from a constellation of geolocation broadcast beacons including beacon 1040 and beacon 1041. Some embodiments use global systems such as the Global Positioning System (GPS), GLONASS, Galileo, Beitou, and LORAN. Some embodiments use indoor positioning systems such as Bluetooth Low Energy beacons. Some embodiments use geolocation information in conjunction with audible signaling to increase the reliability of authentication.

Various embodiments augment conventional two-phase authentication systems with audible signaling or ambient sound sampling as an additional authentication factor.

The invention is not limited to any particular kind of personal device. Some examples of personal devices are mobile phones, personal computers, articles of clothing such as watches, automobiles, and buildings. The invention is not limited to any particular kind of foreign device. Some examples of foreign devices are media players, television sets, personal assistants, vending machines, kiosks, ATMs, checkout registers, library terminals, amusement park rides, office workstations, hotel rooms, buildings, vehicles such as automobiles, airplanes, and ships, and automated billboards. While some embodiments of the invention require no server, embodiments that require a server are not limited to any particular kind of server. Some examples of servers are general authentication servers of cloud service provider, media servers of cloud service provider, bank servers, credit account access servers, consumer product vendor servers, and software-implemented server modules embedded into foreign devices. The invention is not limited to any particular kind of user. Some examples of users are consumers, workers, visitors, drivers, passengers, travelers, women, men, adults, and children.

One system embodiment of the invention comprises a voice-enabled music player foreign device in a home. The music player has a connection to an unsecured, open WiFi network. A user has a mobile phone personal device. The phone has an app provided by a streaming music service vendor, MusiCo. The user, named Kelly, opens the app on the phone. She taps a button in the app to request a temporary code. The app makes an API call to request an access code from the MusiCo server, including the device ID of Kelly's phone. The server notes the device ID and proceeds to chooses a sequentially next five-digit code value from a counter, 84625, and provide it to the phone app. The app displays the five-digit code on the phone. Kelly speaks to the voice-enabled music player, “Hey MusiCo, I'm Kelly@gmail.com, authorize 84625 for three hours, and play my playlist.” The music player recognizes the wake-up phrase “Hey MusiCo”, and begins sending audio from its microphone to the MusiCo server. The server sends the audio through an API call to a back-end speech recognition and natural language understanding (NLU) system. From the audio, the NLU system recognizes the command “authorize 84625” and returns it to the MusiCo server, which thereby confirms that Kelly has authenticated access to the specific music player. The NLU further interprets “for three hours” and sends a command to the MusiCo server telling it to revoke authenticated access after three hours. The MusiCo server then sets a three-hour timer. The NLU system further interprets the audio, “and play my playlist” as a command for MusiCo. The NLU system proceeds to provide the command to the MusicCo server, which in turn begins streaming the music from Kelly's playlist to the music player. After one hours Kelly says, “Hey MusiCo, logout”. The MusiCo server passes the audio for, “logout” to the NLU system, which returns a command to the MusiCo server that causes it to stop music streaming and revoke authentication.

In a similar embodiment, rather than a numerical code, the MusiCo server picks a code from a list of funny words and short phrases. When Kelly reads the code, the MusiCo server uses the speech recognition capability of the NLU system to return the word in order to confirm authentication.

In a similar embodiment, rather than tap a button in the MusiCo app, Kelly says, “Okay, Tom, give me a MusiCo authorization code.” The phone recognizes the wake-up phrase, “Okay, Tom.” The phone proceeds to send audio to a NLU system server, which responds with a command causing the phone to invoke the app and send a code request to the MusiCo server.

In a similar embodiment, Kelly say, “Okay, Tom, I'm Kelly@gmail.com. Play my playlist.” The wake-up phrase “Okay, Tom” wakes the music player. The speech input for “I'm Kelly@gmail.com” is recognized by the NLU system and returned to the MusiCo server. The server looks up the phone device ID and phone number for Kelly@gmail.com, and uses it to send the authorization code, automatically.

In a similar embodiment, when the phone app receives the authorization code, it emits it as an audio word. The music player detects the audio word, decodes its authorization code, and sends it to the MusiCo server. Thereby Kelly does not need to tap or read the phone. She can even leave the phone in her handbag.

In a similar embodiment, the foreign device is a voice-enabled television set.

In some embodiments a service provider, such as MusiCo, provides a key phrase to a user, such as Kelly, on the app. The key phrase is valid for use and reuse for a specific amount of time, such as one hour. In some embodiments, a key phrase becomes invalid immediately after one use.

One system embodiment comprises an ATM machine foreign device. A user inserts a card, speaks an account number, or types a unique username. The ATM requests the user to enter PIN on a keypad. For each key press, the ATM emits an audio word. The user carries a phone with an app installed from the user's bank, associated with the ATM network. The app makes the phone always listening for audio words. This activity requires little processing power, and therefore does not significantly harm phone battery life. When the phone detects each audio word, it encrypts a message and transmits it to the bank over a mobile network, such as a 5G network. The bank receives the message for each button push, and compares it to the messages that it receives from the ATM network. If the bank receives an ATM network request, and did not receive corresponding audio words from the user's phone, the bank sends an alarm signal to the phone app to alert the user that a potential unauthorized access has just occurred. If that occurs while the user is trying to use the ATM, the user removes the phone from a bag or pocket, puts it close to the ATM machine, and tries again. That way the phone will receive the audio words correctly.

In a similar embodiment, the user wears a watch. The watch detects audio words and sends them over a Bluetooth connection to a phone or PD. The phone sends the messages to the bank server.

In a similar embodiment, the FD is a vending machine with cans of soda pop. The user waves her phone or PD near the vending machine, which uses Near Field Communication (NFC) to identify the phone and a payment account. The phone's NFC subsystem wakes up a listening feature. Within about one second, the vending machine emits an audio word that the phone detects and sends to the payment system as a second phase of authentication.

In a similar embodiment, the FD is an automatic checkout system in a retail store. The user is a shopper. The shopper collects any number of items from store shelves. Each item has an RFID tag. When the shopper walks out of the door, the automatic checkout system communicates with an RFID system in the shopper's phone or PD. The checkout system also emits an audio word to the phone. If authentication fails at the payment system server, then the automatic checkout system sounds an alarm to the store security clerk.

One system embodiment is a highly secure workstation access terminal. It comprises a fingerprint sensor, retinal scanner, keyboard for username and password, RFID sensor, and a microphone. The system administrator issues each user with a miniature key fob device that comprises a microphone and speaker and has a unique code. For system access, the workstation user enters a username and password, receives a phone text message with a code, types in the code, provides a fingerprint sample, undergoes a retinal scan, waves and RFID badge, and finally presses a button the key fob, then on the workstation. The workstation emits an audio word that comprises an authorization code encoded with the user's RSA public key. The key fob receives the message, decrypts it, and proceeds to emit a series of whistling sounds to the workstation with the code. Only if the workstation finds success with all authentication methods does the user gain access to the system.

In a similar embodiment, all authentication methods are electronic and signaled digitally over a wired network, except for the whistle. The whistle is emitted as an analog signal on the same wires as the digital network to the AS or authentication server. This frustrates computer hackers that use digital hacking methods. It further ensures that security personnel will hear whistles near terminals, and become suspicious if they hear frequent whistling sounds.

In one system embodiment, a building thermostat is the FD. In response to a user request to change its temperature setting, it sends a code over a Bluetooth connection to a building supervisor's maintenance terminal PD. The building supervisor receives the code and enters it on the thermostat. The thermostat only allows a change to its temperature setting if it receives the correct code. That way, tenants may not change the thermostat setting in a way that would waste energy.

In one system embodiment, the FD is a portable consumer electronic device. The device vendor programs it with a particular home address of a user and sells it at a discount price. The user brings it to the home address. The home has a trusted personal device speaker, such as one built into the home or one built in to a television in the house. When the user turns on the consumer electronic device, it sends a code through the cable TV network to the particular address of the home. The home personal device emits an audio word that enables the consumer electronic device to operate until it turns off.

Embodiments of the invention described herein are merely exemplary, and should not be construed as limiting of the scope or spirit of the invention as it could be appreciated by those of ordinary skill in the art. The disclosed invention is effectively made or used in any embodiment that comprises any novel aspect described herein. All statements herein reciting principles, aspects, and embodiments of the invention are intended to encompass both structural and functional equivalents thereof. It is intended that such equivalents include both currently known equivalents and equivalents developed in the future.

The behavior of either or a combination of humans and machines; instructions that, if executed by one or more computers, would cause the one or more computers to perform methods according to the invention described and claimed; and one or more non-transitory computer readable media arranged to store such instructions embody methods described and claimed herein. Each of more than one non-transitory computer readable medium needed to practice the invention described and claimed herein alone embodies the invention.

Elements described herein as coupled have an effectual relationship realizable by a direct connection or indirectly with one or more other intervening elements.

The scope of the present invention, therefore, is not intended to be limited to the exemplary embodiments shown and described herein. Rather, the scope and spirit of present invention is embodied by the appended claims.

What is claimed is:

1. A method of restricting access of a foreign device to valuable content, the method comprising:
causing emission of an audio signal from the foreign device;
occasionally receiving audio segments from a personal device;
comparing each received audio segments to the emitted audio signal; and
responsive to not matching the emitted audio signal with the received audio segment, restricting access of the foreign device to valuable content.

2. The method of claim 1 wherein the audio signal is music.

3. The method of claim 1 wherein the audio signal comprises at least one audio symbol, the audio symbol comprising a plurality of non-harmonic frequencies.

4. The method of claim 1 wherein the audio signal comprises a frequency component within a range substantially transmissible through cloth and substantially detectable by microphones.

5. The method of claim 4 wherein the frequency component is at a discernable power level.

6. The method of claim 4 wherein the frequency is between 100 Hz and 2500 Hz.

7. The method of claim 1 performed by a server.

8. The method of claim 7 performed by a cloud service provider.

9. The method of claim 1 performed by the foreign device in direct communication with the personal device.

10. The method of claim 1 wherein the audio segment reception occurs less frequently than once per minute and more frequently than once per hour.

11. The method of claim 1 wherein the captured audio segment is less than two seconds long.

12. The method of claim 1 wherein the audio segment is captured until a music recognition system identifies a piece of recorded music.

13. The method of claim 1 further comprising maintaining access after a segment of audio is not matched with the emitted signal.

14. A device comprising:
a speaker for emitting an audio signal;
means of receiving audio segments from a personal device;
memory for storing a digital representation of an emitted audio signal; and
a semiconductor device in communication with the speaker, the means for receiving audio segments, and memory,
wherein the semiconductor device restricts usage responsive to failing to match an emitted audio signal segment in a received audio segment.

15. The device of claim 14 wherein the semiconductor device comprises a computer processor that can restrict usage according to executed software.

16. The device of claim 14 wherein the digital representation is an audio fingerprint.

17. The device of claim 14 further comprising means for speech recognition.

18. A method of authenticating a user on a foreign device, the method comprising:
generating a textual code;
providing the code to a user through an app on a personal device;
receiving audio segments from the foreign device;
invoking speech recognition of the audio segments to extract textual information; and
comparing the textual information to the textual code to determine if there is a match.

19. The method of claim 18 wherein the textual code expires after one use.

20. The method of claim 18 wherein speech recognition is performed remotely.
